(19) United States
(12) Patent Application Publication
(10) Pub. No.: US 2024/0169488 A1
(43) Pub. Date: May 23, 2024

(54) WAVELET-DRIVEN IMAGE SYNTHESIS WITH DIFFUSION MODELS

(71) Applicant: ADOBE INC., SAN JOSE, CA (US)

(72) Inventors: Nan Liu, Urbana, IL (US); Yijun Li, Seattle, WA (US); Michaël Yanis Gharbi, San Francisco, CA (US); Jingwan Lu, Sunnyvale, CA (US)

(21) Appl. No.: 18/056,405

(22) Filed: Nov. 17, 2022

(51) Int. Cl. G06T 5/00; G06T 3/40

(52) U.S. Cl. CPC G06T 5/002; G06T 3/4046; G06T 2207/20064; G06T 2207/20084

(57) ABSTRACT

Systems and methods for synthesizing images with increased high-frequency detail are described. Embodiments are configured to identify an input image including a noise level and encode the input image to obtain image features. A diffusion model reduces a resolution of the image features at an intermediate stage of the model using a wavelet transform to obtain reduced image features at a reduced resolution, and generates an output image based on the reduced image features using the diffusion model. In some cases, the output image comprises a version of the input image that has a reduced noise level compared to the noise level of the input image.

### BACKGROUND

The following relates generally to image processing, and more specifically to image data generation using machine learning. Image processing is a type of data processing that involves manipulating or generating image data. Recently, machine learning (ML) methods have enabled several advanced image processing techniques, such as inpainting, intelligent masking, and the generation of new image content.

Diffusion models are a category of machine learning model that generates data based on stochastic processes. Specifically, diffusion models introduce random noise at multiple levels and train a network to remove the noise. Once trained, a diffusion model can start with random noise and generate data similar to the training data. Diffusion models are able to generate photorealistic images from a rough input, such as sketches, upscaled low-resolution images, and noisy images. Some diffusion models are able to process non-image inputs, such as text prompts, and generate novel images.

### SUMMARY

Embodiments of the present disclosure include a diffusion model with U-Net architecture that includes wavelet transformation layers. By incorporating the wavelet transformations (e.g., in place of down-sampling layers commonly found in a U-Net), diffusion models according to the present disclosure are able to learn from different image patterns at different frequencies. For example, embodiments of the disclosure learn high-frequency information from images from a training dataset and produce high resolution images at inference time.

A method, apparatus, non-transitory computer readable medium, and system for image data generation are described. One or more aspects of the method, apparatus, non-transitory computer readable medium, and system include identifying an input image including a noise level; encoding the input image to obtain image features; reducing a resolution of the image features at an intermediate stage of a diffusion model using a wavelet transform to obtain reduced image features at a reduced resolution; and generating an output image based on the reduced image features using the diffusion model, wherein the output image comprises a version of the input image that has a reduced noise level compared to the noise level of the input image.

A method, apparatus, non-transitory computer readable medium, and system for image data generation are described. One or more aspects of the method, apparatus, non-transitory computer readable medium, and system include identifying a training image; adding noise to the training image to obtain a noisy image; encoding the noisy image to obtain image features; reducing a resolution of the image features at an intermediate stage of a diffusion model using a wavelet transform to obtain reduced image features at a reduced resolution; and training the diffusion model by generating an output image based on the reduced image features, comparing the output image to the training image, and updating parameters of the diffusion model based on the comparison.

An apparatus, system, and method for image data generation are described. One or more aspects of the apparatus, system, and method include a processor; a memory storing instructions executable by the processor; and a diffusion model comprising: an encoder configured to encode the input image to obtain image features; a denoising network comprising resolution reduction layer configured to reduce a resolution of the image features at an intermediate stage of the diffusion model using a wavelet transform to obtain reduced image features at a reduced resolution; and a decoder configured to generate an output image based on the reduced image features.

### BRIEF DESCRIPTION OF THE DRAWINGS

FIG. 1 shows an example of an image synthesizing system according to aspects of the present disclosure.

FIG. 2 shows an example of an image synthesizing apparatus according to aspects of the present disclosure.

FIG. 3 shows an example of a diffusion model according to aspects of the present disclosure.

FIG. 4 shows an example of a comparative U-Net architecture and an example of a wavelet U-Net architecture according to aspects of the present disclosure.

FIG. 5 shows an example of a wavelet transform and an inverse wavelet transform according to aspects of the present disclosure.

FIG. 6 shows an example of a method for providing a synthesized image to a user according to aspects of the present disclosure.

FIG. 7 shows an example of a diffusion process according to aspects of the present disclosure.

FIG. 8 shows an example of a method for synthesizing an image according to aspects of the present disclosure.

FIG. 9 shows an example of a method for using a wavelet transform to generate reduced image features according to aspects of the present disclosure.

FIG. 10 shows an example of a method for training a diffusion model according to aspects of the present disclosure.

FIG. 11 shows an example of a method for training a wavelet diffusion model according to aspects of the present disclosure.

FIG. 12 shows an example of a computing device for image synthesis according to aspects of the present disclosure.

### DETAILED DESCRIPTION

The present disclosure relates to using machine learning for image generation. Several models have been developed for image synthesis. Recently, denoising diffusion probabilistic models (“diffusion models”) have been used for image synthesis, as they are able to generate photorealistic results with minimal input. Examples of these diffusion models include DALLE-2, Imagen, and Latent Diffusion. These models are able to create novel images after being trained on images from datasets.

These recent generative models generate visual content from basic inputs. However, many models struggle to produce images with high frequency information. High frequency information in images corresponds to textures and other rapidly changing information across the pixel space. Twigs on a tree, hair detail, and texture are some examples of high frequency information. From observational data, generative models are unable to produce images with high frequency information because they are unable to learn from high frequency information during training.

One explanation for these models' lack of ability to learn high frequency information is the architecture of the model. Many diffusion models use a U-Net architecture, which provides fast and impressive performance over other models in image generation areas. U-Net is an artificial neural network (ANN) architecture that comprises many convolutional layers. The layers include pooling operations which downsample an input, and up-convolution operations which up-sample the input, resulting in a schematic ‘U’ shape. Many U-Nets further include a series of residual blocks, as well as skip connections to propagate signals between the downsampling and upsampling paths. The U-Net architecture includes a bottleneck in the middle (at the bottom of the “U”) to preserve and learn the most important information during training—i.e., the parameters with the largest effect in the image generation process.

However, the downsampling operations can cause a lossy transfer of information between encodings in the U-Net. The downsampling and upsampling configuration is able to transfer coarse features of an input image during inference. These coarse features are the most salient for reconstructing new objects, but they have less information about highly detailed texture. Some methods attempt to compensate by modifying training and sampling procedures. For example, some methods include increasing the number of high-frequency images in the training data. However, these methods do not fully address the core issue of learning from high-frequency signals in the training data.

In addition to, or as an alternative to adjusting training procedure, the present disclosure proposes directly changing the architecture of the model. For example, embodiments maintain the U-Net “shape” of the model, but instead of using downsampling layers, embodiments substitute wavelet transform layers. The wavelet transformations produce a reduced resolution image features in one channel, and can produce additional channels of other information, such as edge or texture detail information. Furthermore, unlike conventional downsampling layers, information isn't lost during the process. A high resolution image or image features can be constructed using an inverse wavelet transform, which retains the high frequency data.

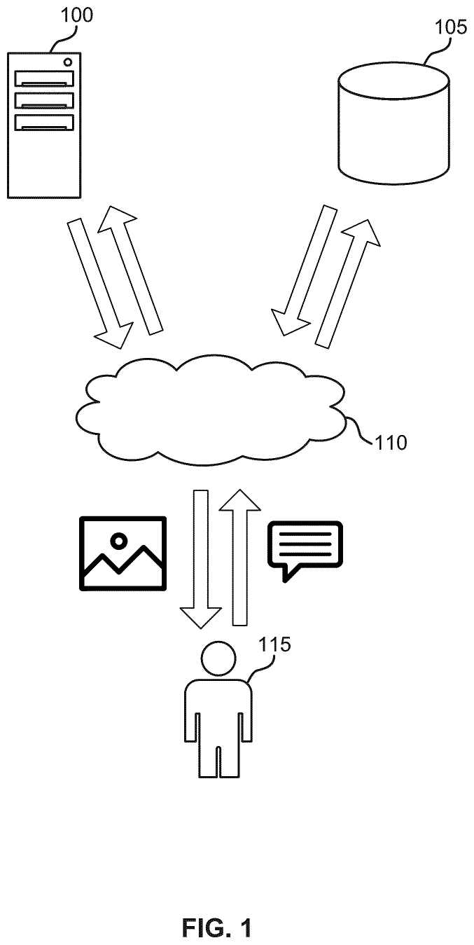

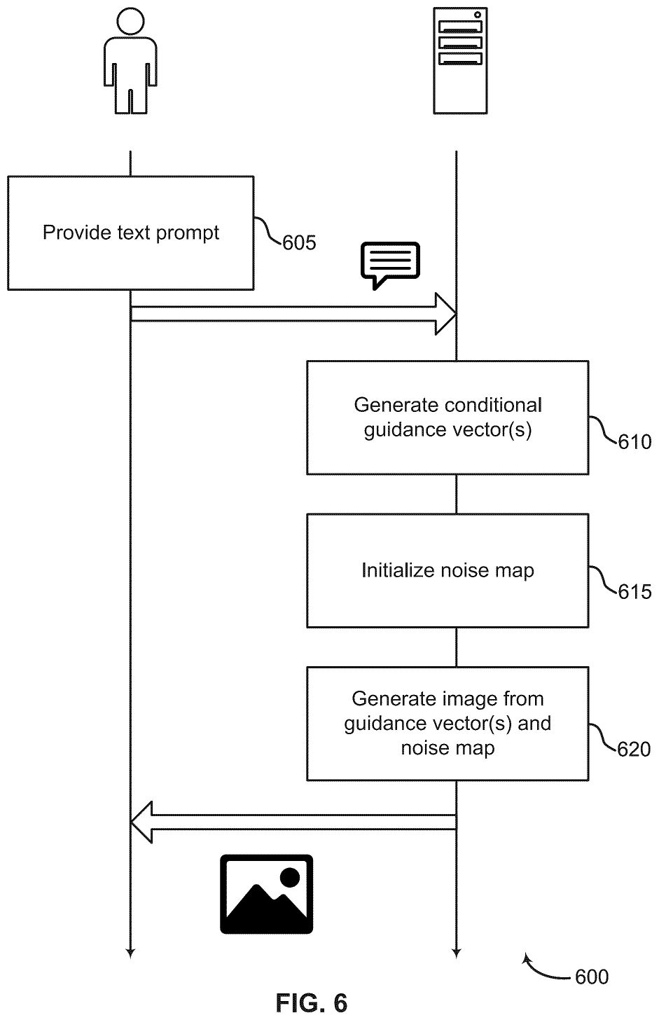

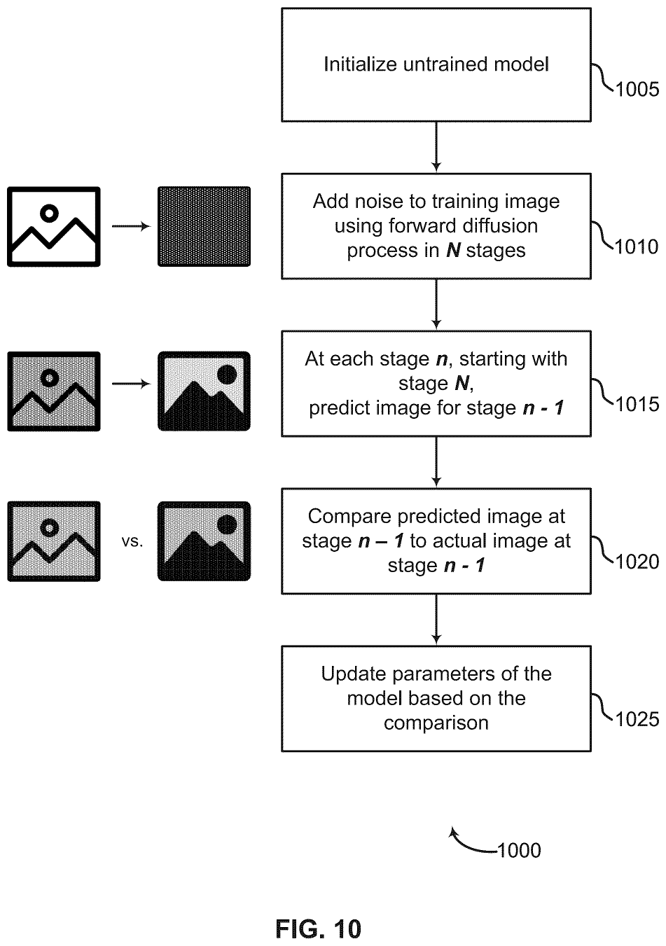

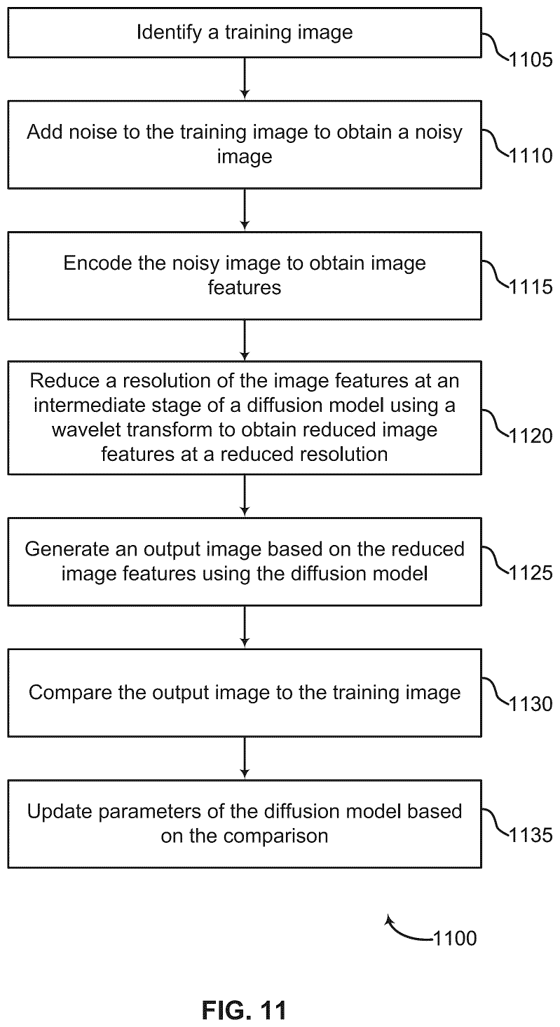

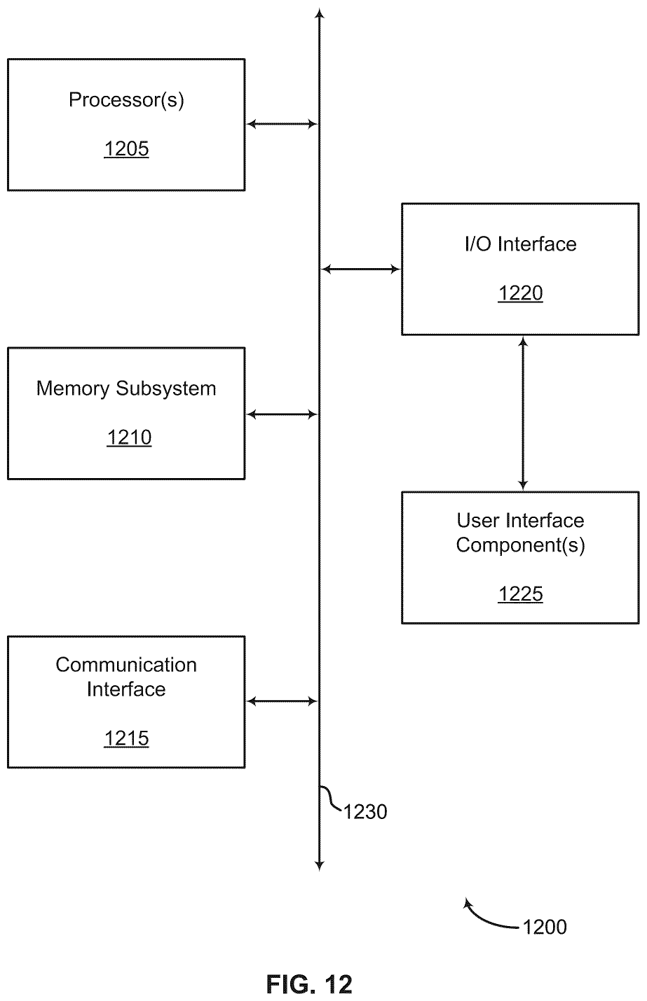

Details regarding the architecture of an image synthesizing system are provided with reference to FIGS. 1-5. Details of methods for synthesizing an image with high frequency information are provided with reference to FIGS. 6-9. Training methods are discussed with reference to FIGS. 10-11. A computing device that may be used to implement an image synthesizing apparatus is described with reference to FIG. 12.

Accordingly, embodiments of the present disclosure provide an improvement over existing image generation models by enabling synthesis of images with realistic high frequency information (e.g., textures, patterns, and details) as well as low frequency information (e.g., structures and large-scale patterns). The inventive concepts can be applied to all types of diffusion models that contain upsampling and downsampling layers. Further, embodiments can synthesize the high frequency information without changing training or sampling procedures during initial training of the model. This enables the generation of images with more realistic looking textures as well as large scale structural patterns.

### Image Synthesis System

An apparatus for image data generation is described. One or more aspects of the apparatus include a processor; a memory storing instructions executable by the processor; and a diffusion model comprising: an encoder configured to encode the input image to obtain image features; a denoising network comprising resolution reduction layer configured to reduce a resolution of the image features at an intermediate stage of the diffusion model using a wavelet transform to obtain reduced image features at a reduced resolution; and a decoder configured to generate an output image based on the reduced image features.

Some examples of the apparatus, system, and method further include a training component configured to update parameters of the diffusion model. Some examples of the apparatus, system, and method further include a user interface configured to receive a text prompt, wherein the diffusion model is configured to condition the output image based on the text prompt. In some aspects, the denoising network comprises a U-Net architecture. In some aspects, the diffusion model comprises a latent diffusion model.

Some examples of the apparatus, system, and method further include a noise component configured to add noise to an image to obtain the input image. In some aspects, the denoising network includes an inverse wavelet transform configured to increase the reduced resolution of the reduced image features to obtain processed image features at the resolution of the image features.

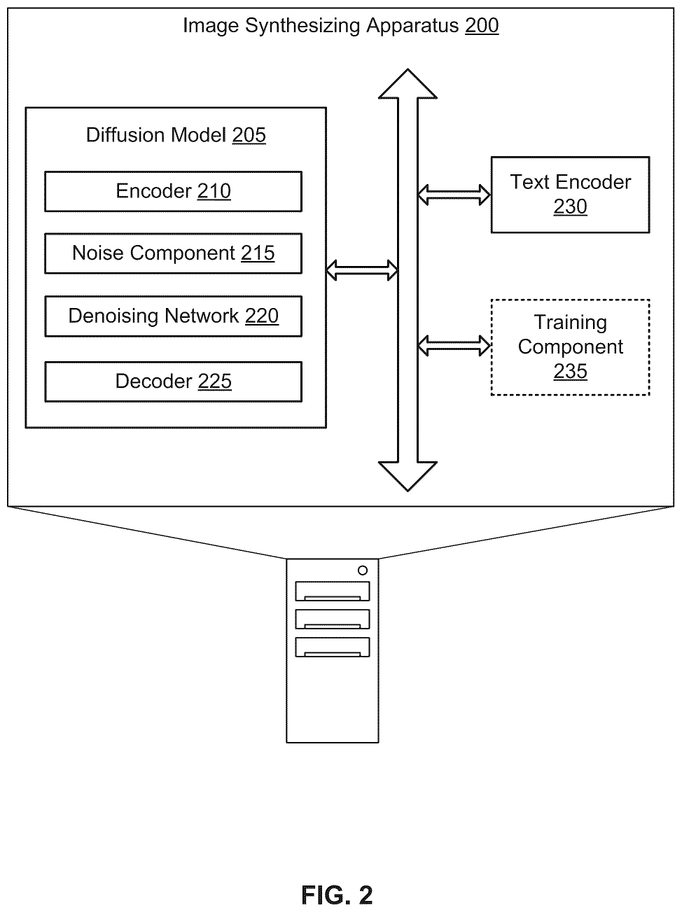

FIG. 1 shows an example of an image synthesizing system according to aspects of the present disclosure. The example shown includes image synthesizing apparatus 100, database 105, network 110, and user 115. Image synthesizing apparatus 100 is an example of, or includes aspects of, the corresponding element described with reference to FIG. 2.

In an example process, user 115 provides an input to the system via a user interface. The input may be a low quality or low detail image, or a text prompt. In some cases, the input includes an object or scene with high frequency detail. Image synthesizing apparatus 100 receives the input and processes it using a diffusion model. The processing synthesizes an image that includes the high frequency detail as well as low frequency structure. Then, the system provides the image to user 115, through, for example, a user interface.

One or more components of image synthesizing apparatus 100 may be implemented on a server, or multiple servers connected through network 110. A server provides one or more functions to users linked by way of one or more of the various networks. In some cases, the server includes a single microprocessor board, which includes a microprocessor responsible for controlling all aspects of the server. In some cases, a server uses a microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Embodiments of the image synthesizing system include a database, such as database 105. Database 105 may contain training data, model parameters, or other information used by the system to synthesize images. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, user 115 interacts with the database controller. In other cases, the database controller may operate automatically without user interaction.

Network 110 is used to transfer information between user 115, database 105, and image synthesizing apparatus 100. Network 110 can be referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image synthesizing apparatus 200 according to aspects of the present disclosure. The example shown includes image synthesizing apparatus 200, diffusion model 205, text encoder 230, and training component 235.

Embodiments of image synthesizing apparatus 200 include several components. The term ‘component’ is used to partition the functionality enabled by the processors and the executable instructions included in the computing device used to implement image synthesizing apparatus 200 (such as the computing device described with reference to FIG. 12). The partitions may be implemented physically, such as through the use of separate circuits or processors for each component, or may be implemented logically via the architecture of the code executable by the processors.

In one aspect, diffusion model 205 includes encoder 210, noise component 215, denoising network 220, and decoder 225. In some embodiments, diffusion model 205 includes one or more convolutional neural networks (CNNs). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some embodiments of diffusion model 205, one or more (or all) of the convolutional blocks are replaced with “ResBlocks,” or units of a ResNet. A ResNet is a neural network architecture that addresses issues associated with training deep neural networks. It operates by including identity shortcut connections that skip one or more layers of the network. In a ResNet, stacking additional layers doesn't degrade performance or introduce training errors because skipping layers avoids the vanishing gradient problem of deep networks. In other words, the training gradient can follow “shortcuts” through the deep network. Weights are adjusted to “skip” a layer and amplify a previous skipped layer. In an example scenario, weights for an adjacent layer are adjusted and weights are not applied to an upstream layer.

According to some aspects, diffusion model 205 generates an output image based on the reduced image features generated by denoising network 220. In some examples, diffusion model 205 computes a wavelet value corresponding to each of a set of basis images to obtain a set of wavelet values for each pixel of the reduced image features, where the reduced image features include a channel corresponding to each of the set of wavelet values. In some examples, diffusion model 205 conditions the generation of the output image based on a text encoding of a text prompt. In some aspects, the text prompt describes a texture, and the output image depicts the texture.

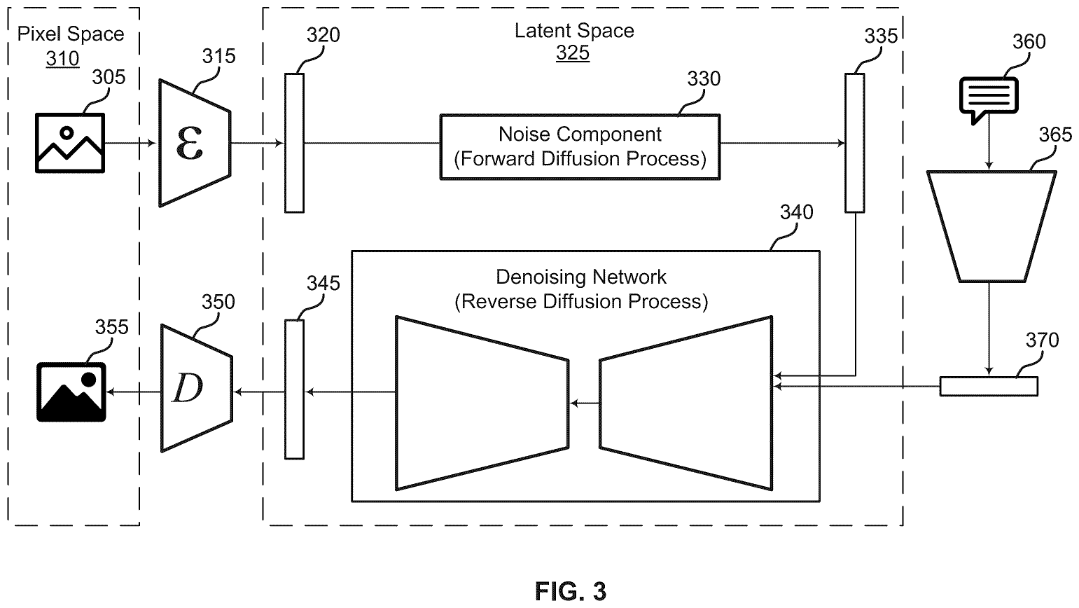

Diffusion model 205 is an example of, or includes aspects of, the corresponding element described with reference to FIG. 3. Encoder 210, noise component 215, denoising network 220, decoder 225, and text encoder 230 will be discussed in detail with reference to FIG. 3.

Training component 235 updates parameters of diffusion model 205 during a training stage. The training includes adding noise to training images using, e.g., noise component 215, and progressively removing the noise from the training image using, e.g., denoising network 220. For each level of removed noise, training component 235 compares the prediction of diffusion model 205 with a ground-truth version of the training image, and updates parameters of diffusion model 205 based on the comparison.

In some examples, training component 235 computes a reconstruction loss based on the training image and an output image of diffusion model 2015, where the parameters of diffusion model 205 are updated based on the reconstruction loss. Training procedures will be described in detail with reference to FIGS. 10-11.

FIG. 3 shows an example of a diffusion model 300 according to aspects of the present disclosure. The example shown includes diffusion model 300, original image 305, pixel space 310, encoder 315, original image features 320, latent space 325, noise component 330, noisy features 335, denoising network 340, denoised image features 345, decoder 350, output image 355, text prompt 360, text encoder 365, and guidance features 370.

Diffusion model 300, image encoder 315, noise component 330, denoising network 340, image decoder 350, and text encoder 365 are examples of, or include aspects of, the corresponding elements described with reference to FIG. 2.

In some aspects, the denoising network 340 includes a U-Net architecture. According to some aspects, denoising network 340 reduces a resolution of the image features at an intermediate stage of diffusion model 300 using a wavelet transform to obtain reduced image features at a reduced resolution. In some examples, denoising network 340 reduces the resolution of the reduced image features at a subsequent intermediate stage of the diffusion model 300 using a subsequent wavelet transform to obtain further reduced image features. In some examples, denoising network 340 increases the reduced resolution of the reduced image features using an inverse wavelet transform to obtain processed image features at the resolution of the image features. In some aspects, the input image includes random noise.

Embodiments of diffusion model 300 include a guided latent diffusion model. The guided latent diffusion model depicted in FIG. 3 is an example of, or includes aspects of, the diffusion model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, diffusion model 300 may take an original image 305 in a pixel space 310 as input and apply image encoder 315 to convert original image 305 into original image features 320 in a latent space 325. Then, noise component 330 gradually adds noise to the original image features 320 to obtain noisy features 335 (also in latent space 325) at various noise levels.

Next, a reverse diffusion process (e.g., a U-Net ANN denoising network 340) gradually removes the noise from the noisy features 335 at the various noise levels to obtain denoised image features 345 in latent space 325. In some examples, the denoised image features 345 are compared to the original image features 320 at each of the various noise levels, and parameters of the denoising network 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the denoising network 340.

In some cases, image encoder 315 and image decoder 350 are pre-trained prior to training the denoising network 340. In some examples, they are trained jointly, or the image encoder 315 and image decoder 350 and fine-tuned jointly with the denoising network 340.

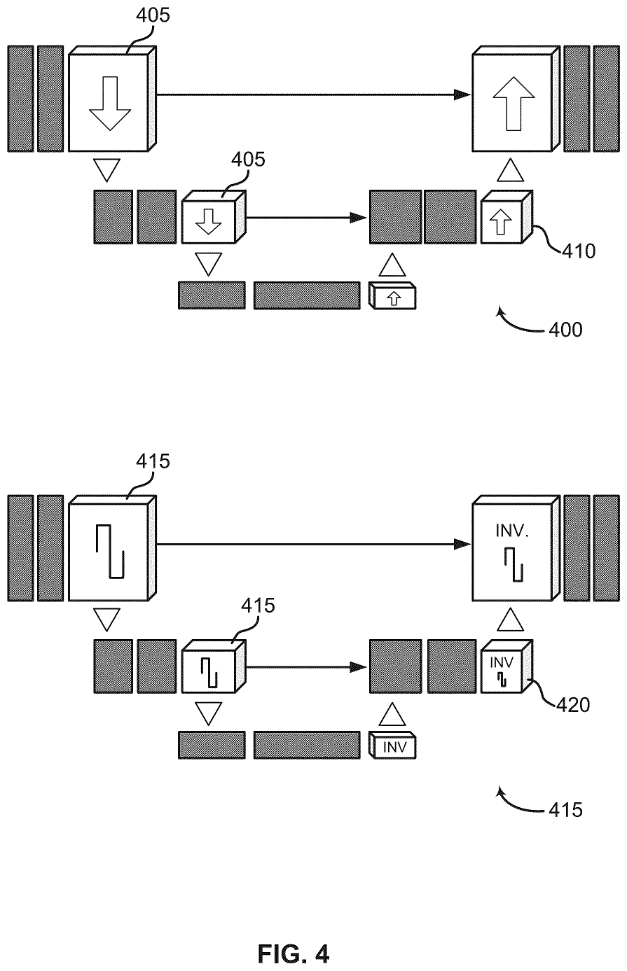

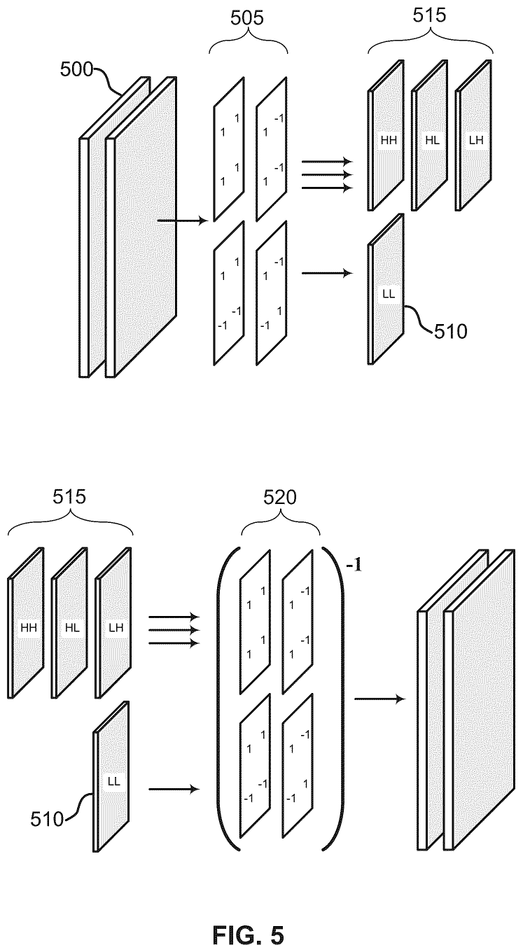

Embodiments of denoising network 340 include an ANN with a U-Net architecture. However, instead of downsampling blocks and upsampling blocks, embodiments utilize wavelet transform blocks and inverse wavelet transform blocks, respectively, to reduce the resolution of image features and increase the resolution of image features throughout the denoising process. The wavelet transform blocks perform a discrete wavelet transform (DWT) on the noisy features 335 to decompose the image into various image signals including low frequency and high frequency information. The DWT may be implemented through a combination operation of the input image signal with one or more matrices representing a discrete wavelet. The inverse wavelet transform blocks perform an inverse process to recompose the signals into an image. Combined with the denoising operations, this process synthesizes new images. Additional detail regarding the wavelet transform will be discussed with reference to FIGS. 4-5.

The denoising network 340 can also be guided based on a text prompt 360, or another guidance prompt, such as an image, a layout, a segmentation map, etc. The text prompt 360 can be encoded using a text encoder 365 (e.g., a multimodal encoder, such as a CLIP encoder) to obtain guidance features 370. In some embodiments, guidance features 370 are encoded into a in guidance space. The guidance features 370 can be combined with the noisy features 335 at one or more layers of the denoising network 340 to ensure that the output image 355 includes content described by the text prompt 360. For example, guidance features 370 can be combined with the noisy features 335 using a cross-attention block within the reverse denoising network 340.

FIG. 4 shows an example of a comparative U-Net 400 architecture and a wavelet U-Net 415 architecture according to aspects of the present disclosure. The example shown includes comparative U-Net 400, downsampling block 405, upsampling block 410, wavelet U-Net 415, wavelet transform block 420, and inverse wavelet transform block 425.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using an up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

In an example, a comparative U-Net 400 includes downsampling blocks 405 and upsampling blocks 410. The downsampling blocks 405 may include convolutional layers with adjustable parameters such as stride, etc., which are configured to reduce a resolution of an input image or input features. Upsampling blocks 410 are used to increase the resolution of image features back to the original resolution of the input. The downsampling allows the U-Net to propagate low frequency features through the denoising path, which, in some cases, form a greater basis for a generated image than high frequency features. However, this downsampling is a lossy process, and produces an approximation of low frequency signals while losing high frequency. This can result in generated images with decreased high frequency information. For example, fine detail such as twigs on a tree, folds in clothing, individual hairs, etc. might not be reproduced by diffusion models that use comparative U-Net 400.

In contrast, diffusion models of the present disclosure include wavelet U-Net 415. The downsampling blocks 405 are replaced with wavelet transform blocks 420, and the upsampling blocks 410 are replaced with inverse wavelet transform block 425. The wavelet transform blocks 420 apply a wavelet transform, such as DWT, to an input signal. When the dimensions are reduced, this operation is sometimes referred to as “wavelet pooling.” The DWT may use Haar wavelets, Daubechies wavelets, dual-tree complex wavelet transforms, or any variation. The transform produces an image at reduced resolution, but additionally produces channels or additional “images” that include high frequency information. By propagating this high frequency information through the U-Net, diffusion models of the present disclosure enforce a “high-frequency awareness,” which allows the model to learn to reproduce high-frequency information.

The inverse wavelet transform blocks 425 of wavelet U-Net 415 are used to increase the resolution of the image features back to an original resolution. The inverse process uses the plurality of channels produced by the DWT process to reconstruct image features at a high resolution, and with the high frequency information.

FIG. 5 shows an example of a wavelet transform and an inverse wavelet transform according to aspects of the present disclosure. The example shown includes input signal 500, wavelet transform operation 505, low frequency signal 510, high frequency signal(s) 515, and inverse wavelet transform operation 520.

In this example, wavelet transform operation 505 is applied to input signal 500. Some implementations of the transform include a matrix multiplication between input signal 500 and a matrix representation of a wavelet, such as the Haar wavelet. In an example, the product of the transform yields low frequency signal 510 and high frequency signals 515. ‘LL’ or (“low low”) is sometimes used to refer to low frequency signal 510, which represents an approximation of the input image signal at a reduced resolution. High frequency signals 515 may include three channels, ‘LH’, ‘HL’, and ‘HR.’ In some embodiments, these channels refer to sub-bands of frequency information corresponding to horizontal features, vertical features, and diagonal features, respectively.

Inverse wavelet transform operation 520 may receive low frequency signal 510 and high frequency signals 515 as input. Then, inverse wavelet transform operation 520 reconstructs an image signal at an increased resolution using both the low frequency and high frequency information. In some cases, such as in the denoising network described with reference to FIG. 3, wavelet transform operation 505 is applied to an image signal several times during a down-scaling path, and inverse wavelet transform operation 520 is applied several times during an up-scaling path.

### Image Synthesis

A method for image data generation is described. One or more aspects of the method include identifying an input image; encoding the input image to obtain image features; reducing a resolution of the image features at an intermediate stage of a diffusion model using a wavelet transform to obtain reduced image features at a reduced resolution; and generating an output image based on the reduced image features using the diffusion model. In some aspects, the input image comprises random noise.

Some examples of the method, apparatus, non-transitory computer readable medium, and system further include identifying a plurality of basis images. In some cases, the basis images a produced by the wavelet transform. Some examples further include computing a wavelet value corresponding to each of the plurality of basis images to obtain a plurality of wavelet values for each pixel of the reduced image features, wherein the reduced image features include a channel corresponding to each of the plurality of wavelet values.

Some examples of the method, apparatus, non-transitory computer readable medium, and system further include reducing the resolution of the reduced image features at a subsequent intermediate stage of the diffusion model using a subsequent wavelet transform to obtain further reduced image features. Some examples further include increasing the reduced resolution of the reduced image features using an inverse wavelet transform to obtain processed image features at the resolution of the image features.

Some examples of the method, apparatus, non-transitory computer readable medium, and system further include encoding a text prompt to obtain a text encoding. Some examples further include conditioning the generation of the output image based on the text encoding. In some aspects, the text prompt describes a texture, and the output image depicts the texture.

FIG. 6 shows an example of a method 600 for providing a synthesized image to a user according to aspects of the present disclosure. In some examples, these operations are performed by a system including a processor executing a set of codes to control functional elements of an apparatus such as the apparatus described in FIG. 2.

Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, a user provides a text prompt describing content to be included in a generated image. For example, a user may provide the prompt “a person playing with a cat”. In some examples, guidance can be provided in a form other than text, such as via an image, a sketch, or a layout.

At operation 610, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 615, a noise map is initialized that includes random noise. The noise map may be in a pixel space or a latent space. By initializing an image with random noise, different variations of an image including the content described by the conditional guidance can be generated.

At operation 620, the system generates an image based on the noise map and the conditional guidance vector. For example, the image may be generated using a reverse diffusion process as described with reference to FIG. 3. The reverse diffusion process includes wavelet transforms and inverse wavelet transforms, and is capable of generating images with increased texture detail.

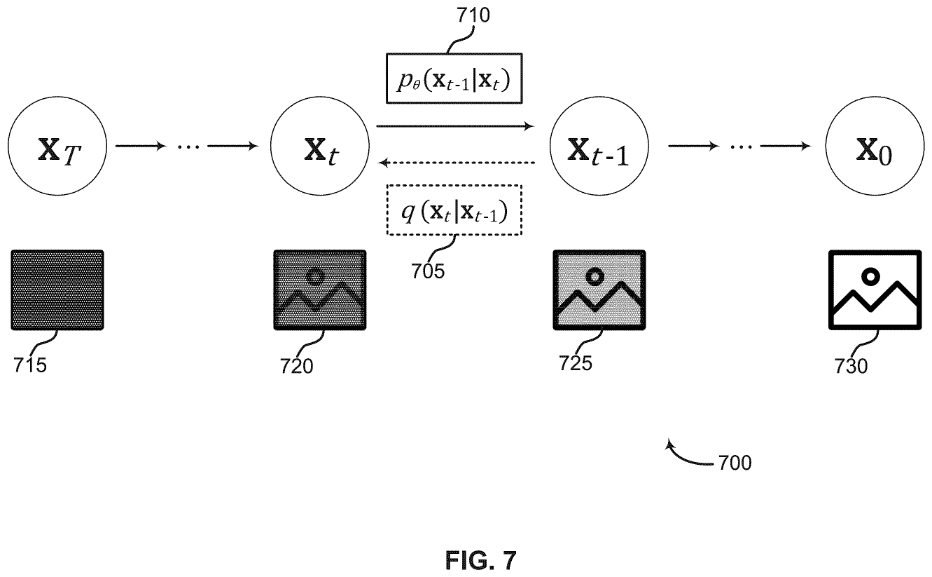

FIG. 7 shows a diffusion process 700 according to aspects of the present disclosure. As described above with reference to FIG. 3, a diffusion model can include both a forward diffusion process 705 for adding noise to an image (or features in a latent space) and a reverse diffusion process 710 (e.g., the denoising network) for denoising the images (or features) to obtain a denoised image. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate images with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 710, the model begins with noisy data x_{T}, such as a noisy image 715 and denoises the data to obtain the p(xₜ₋₁|xₜ). At each step t−1, the reverse diffusion process 710 takes xₜ, such as first intermediate image 720, and t as input. Here, t represents a step in the sequence of transitions associated with different noise levels, The reverse diffusion process 710 outputs xₜ₋₁, such as second intermediate image 725 iteratively until x_{T} is reverted back to x₀, the original image 730. The reverse process can be represented as:

p_{θ}(xₜ₋₁|xₜ):=N(xₜ₋₁;μ_{θ}(xₜ,t),Σ_{θ}(xₜ,t)). (1)

The joint probability of a sequence of samples in the Markov chain can be written as a product of conditionals and the marginal probability:

x_{T}:p_{θ}(x_{0:T}):=p(x_{T})Πₜ₌₁^{T}p_{θ}(xₜ₋₁|xₜ), (2)

where p(x_{T})=N(x_{T}; 0, I) is the pure noise distribution as the reverse process takes the outcome of the forward process, a sample of pure noise, as input and Πₜ₌₁^{T} p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables X₁, . . . , x_{T} represent noisy images, and \tilde{x} represents the generated image with high image quality.

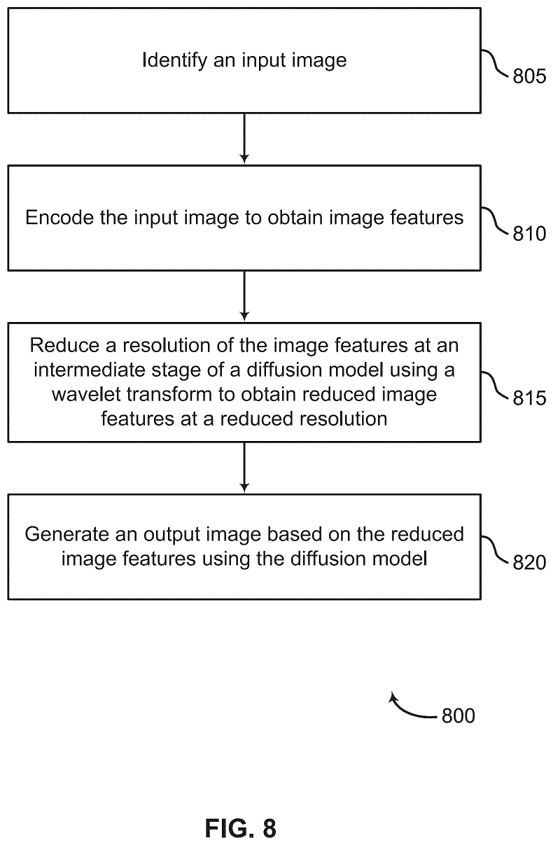

FIG. 8 shows an example of a method 800 for synthesizing an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system identifies an input image. In some cases, the operations of this step refer to, or may be performed by, an image synthesizing apparatus as described with reference to FIGS. 1 and 2. In cases where the image generation is conditioned on a text prompt, the input image may be pure noise.

At operation 810, the system encodes the input image to obtain image features. In some cases, the operations of this step refer to, or may be performed by, an encoder as described with reference to FIGS. 2 and 3. In some embodiments, the encoder encodes the input image into a latent space as described with reference to FIG. 3.

At operation 815, the system reduces a resolution of the image features at an intermediate stage of a diffusion model using a wavelet transform to obtain reduced image features at a reduced resolution. In some cases, the operations of this step refer to, or may be performed by, a denoising network as described with reference to FIGS. 2 and 3. Additional detail regarding the wavelet transform is provided with reference to FIGS. 4-5.

At operation 820, the system generates an output image based on the reduced image features using the diffusion model. In some cases, the operations of this step refer to, or may be performed by, a diffusion model as described with reference to FIGS. 2 and 3. The output image may be generated using the diffusion process as described with reference to FIG. 7.

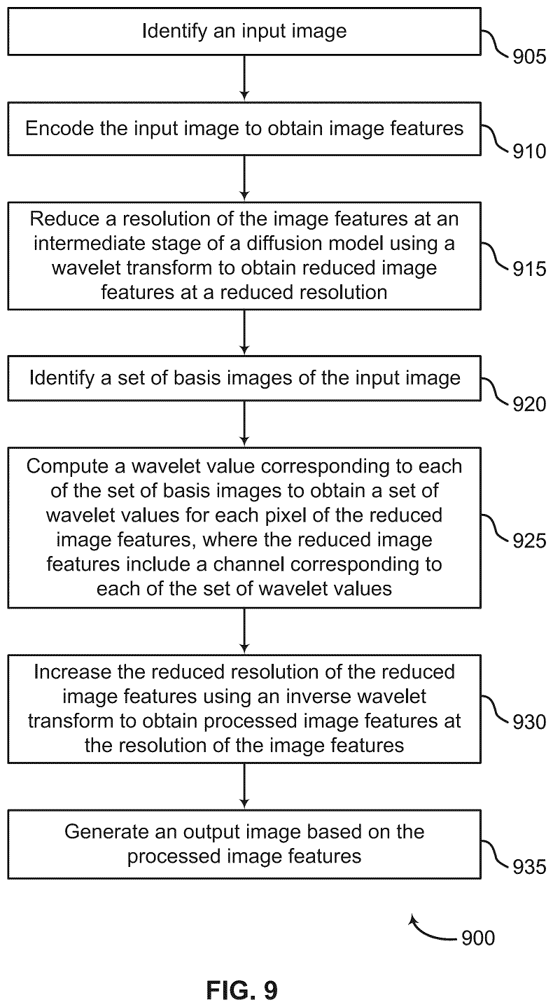

FIG. 9 shows an example of a method 900 for using a wavelet transform to generate reduced image features according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system identifies an input image. In some cases, the operations of this step refer to, or may be performed by, an image synthesizing apparatus as described with reference to FIGS. 1 and 2. At operation 910, the system encodes the input image to obtain image features. In some cases, the operations of this step refer to, or may be performed by, an encoder as described with reference to FIGS. 2 and 3.

At operation 915, the system reduces a resolution of the image features at an intermediate stage of a diffusion model using a wavelet transform to obtain reduced image features at a reduced resolution. In some cases, the operations of this step refer to, or may be performed by, a denoising network as described with reference to FIGS. 2 and 3. For example, the denoising network may be or include a U-Net model as described with reference to FIG. 4. The U-Net model may include several wavelet transform blocks configured to process an input signal into a low frequency image and high frequency images. In some embodiments, these images are not in a pixel space, but rather in a latent space.

At operation 920, the system identifies a set of basis images of the input image. In some cases, the operations of this step refer to, or may be performed by, a diffusion model as described with reference to FIGS. 2 and 3. The basis images may be the low frequency and high frequency images described above, and described with reference to FIG. 5.

At operation 925, the system computes a wavelet value corresponding to each of the set of basis images to obtain a set of wavelet values for each pixel of the reduced image features, where the reduced image features include a channel corresponding to each of the set of wavelet values. In some cases, the operations of this step refer to, or may be performed by, an image synthesizing apparatus as described with reference to FIGS. 1 and 2. In some cases, the wavelet values are represented in the form of matrices or vectors.

At operation 930, the system increases the reduced resolution of the reduced image features using an inverse wavelet transform to obtain processed image features at the resolution of the image features. In some cases, the operations of this step refer to, or may be performed by, a diffusion model as described with reference to FIGS. 2 and 3. For example, the denoising network of the diffusion model may include several inverse wavelet transform blocks configured to reconstruct the reduced image features into a higher resolution.

At operation 935, the system generates an output image based on the processed image features. The output image may include high frequency information. For example, the output image may include high frequency information corresponding to a text prompt or to the input image. High frequency information refers to image data with a high amount of local contrast. Small tree branches, hair detail, and texture are some examples of high frequency information.

### Training

A method for image data generation is described. One or more aspects of the method include identifying a training image; adding noise to the training image to obtain a noisy image; encoding the noisy image to obtain image features; reducing a resolution of the image features at an intermediate stage of a diffusion model using a wavelet transform to obtain reduced image features at a reduced resolution; generating an output image based on the reduced image features using the diffusion model; comparing the output image to the training image; and updating parameters of the diffusion model based on the comparison. Some examples further include computing a reconstruction loss based on the training image and the output image, wherein the parameters of the diffusion model are updated based on the reconstruction loss.

Some examples of the method, apparatus, non-transitory computer readable medium, and system further include adding the noise to the training image at a plurality of noise levels to obtain a plurality of noisy images corresponding to the plurality of noise levels, respectively, wherein the parameters of the diffusion model are updated based on each of the plurality of noise levels using the plurality of noisy images.

Some examples of the method, apparatus, non-transitory computer readable medium, and system further include identifying a plurality of basis images. In some cases, the method, apparatus, non-transitory computer readable medium, and system further include computing a wavelet value corresponding to each of the plurality of basis images to obtain a plurality of wavelet values for each pixel of the reduced image features, wherein the reduced image features include a channel corresponding to each of the plurality of wavelet values.

Some examples further include reducing the resolution of the reduced image features at a subsequent intermediate stage of the diffusion model using a subsequent wavelet transform to obtain further reduced image features. Some examples further include increasing the reduced resolution of the reduced image features to obtain processed image features at the resolution of the image features.

FIG. 10 shows an example of a method 1000 for training a diffusion model according to aspects of the present disclosure. The method shown represents an example for training a reverse diffusion process as described above with reference to FIG. 7. In some examples, these operations are performed by a system including a processor executing a set of codes to control functional elements of an apparatus, such as the apparatus described in FIG. 3.

At operation 1005, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

At operation 1010, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

FIG. 11 shows an example of a method 1100 for training a wavelet diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In many cases, diffusion models that incorporate the wavelet transform and inverse wavelet transform operations described herein may be trained in similarly to conventional diffusion models. Accordingly, the process flow or workflow of diffusion model users may be maintained.

At operation 1105, the system identifies a training image. In some cases, the operations of this step refer to, or may be performed by, an image synthesizing apparatus as described with reference to FIGS. 1 and 2. The training image may be provided by a user through a user interface, or copied from a database as described with reference to FIG. 1. Some examples of the training image include meta-data, such as tags or labels.

At operation 1110, the system adds noise to the training image to obtain a noisy image. In some cases, the operations of this step refer to, or may be performed by, a noise component as described with reference to FIGS. 2 and 3. The noise may be added as Gaussian noise, though the present disclosure is not limited thereto.

At operation 1115, the system encodes the noisy image to obtain image features. In some cases, the operations of this step refer to, or may be performed by, an encoder as described with reference to FIGS. 2 and 3. In some examples, the image features are encoded into a latent space that can be shared by other embeddings, such as CLIP embeddings.

At operation 1120, the system reduces a resolution of the image features at an intermediate stage of a diffusion model using a wavelet transform to obtain reduced image features at a reduced resolution. In some cases, the operations of this step refer to, or may be performed by, a denoising network as described with reference to FIGS. 2 and 3. Additional detail regarding the wavelet transform is provided with reference to FIGS. 4 and 5.

At operation 1125, the system generates an output image based on the reduced image features using the diffusion model. In some cases, the operations of this step refer to, or may be performed by, a diffusion model as described with reference to FIGS. 2 and 3. The system may generate (i.e., synthesize) the image according to the diffusion process as described with reference to FIGS. 4 and 7.

At operation 1130, the system compares the output image to the training image. In some cases, the operations of this step refer to, or may be performed by, a training component as described with reference to FIG. 2. For example, the training component may compute a reconstruction loss.

At operation 1135, the system updates parameters of the diffusion model based on the comparison. In some cases, the operations of this step refer to, or may be performed by, a training component as described with reference to FIG. 2. In some examples, as described with reference to FIG. 10, the system compares the output image to the training image at multiple levels of noise, and updates parameters of the diffusion model at each level.

FIG. 12 shows an example of a computing device 1200 for image synthesis according to aspects of the present disclosure. In one aspect, computing device 1200 includes processor(s) 1205, memory subsystem 1210, communication interface 1215, I/O interface 1220, user interface component(s) 1225, and channel 1230.

In some embodiments, computing device 1200 is an example of, or includes aspects of, image synthesizing apparatus of FIGS. 1 and 2. In some embodiments, computing device 1200 includes one or more processors 1205 that can execute instructions stored in memory subsystem 1210 to identify an input image; encode the input image to obtain image features; reduce a resolution of the image features at an intermediate stage of a diffusion model using a wavelet transform to obtain reduced image features at a reduced resolution; and generate an output image based on the reduced image features using the diffusion model.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote control device interfaced with a user interface directly or through the I/O controller), or a combination thereof. In some cases, user interface component(s) 1225 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, a controller, a microcontroller, or a state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
identifying an input image including a level of noise;
encoding the input image to obtain image features;
reducing a resolution of the image features at an intermediate stage of a diffusion model using a wavelet transform to obtain reduced image features at a reduced resolution; and
generating an output image based on the reduced image features using the diffusion model, wherein the output image comprises a version of the input image that has a reduced noise level compared to the noise level of the input image.

2. The method of claim 1, further comprising:
identifying a plurality of basis images; and
computing a wavelet value corresponding to each of the plurality of basis images to obtain a plurality of wavelet values for each pixel of the reduced image features, wherein the reduced image features include a channel corresponding to each of the plurality of wavelet values.

3. The method of claim 1, further comprising:
reducing the resolution of the reduced image features at a subsequent intermediate stage of the diffusion model using a subsequent wavelet transform to obtain further reduced image features.

4. The method of claim 1, further comprising:
increasing the reduced resolution of the reduced image features using an inverse wavelet transform to obtain processed image features at the resolution of the image features.

5. The method of claim 1, wherein:
the input image comprises random noise.

6. The method of claim 1, further comprising:
encoding a text prompt to obtain a text encoding; and
conditioning the generation of the output image based on the text encoding.

7. The method of claim 6, wherein:
the text prompt describes a texture, and the output image depicts the texture.

8. A method for image processing, comprising:
identifying a training image;
adding noise to the training image to obtain a noisy image;
encoding the noisy image to obtain image features;
reducing a resolution of the image features at an intermediate stage of a diffusion model using a wavelet transform to obtain reduced image features at a reduced resolution; and
training the diffusion model to generate images based on the noisy image based on the reduced image features.

9. The method of claim 8, wherein the training further comprises:
generating an output image based on the reduced image features;
computing a reconstruction loss by comparing the output image to the training image; and
updating parameters of the diffusion model based on the reconstruction loss.

10. The method of claim 8, further comprising:
adding the noise to the training image at a plurality of noise levels to obtain a plurality of noisy images corresponding to the plurality of noise levels, respectively, wherein the parameters of the diffusion model are updated based on each of the plurality of noise levels using the plurality of noisy images.

11. The method of claim 8, further comprising:
identifying a plurality of basis images; and
computing a wavelet value corresponding to each of the plurality of basis images to obtain a plurality of wavelet values for each pixel of the reduced image features, wherein the reduced image features include a channel corresponding to each of the plurality of wavelet values.

12. The method of claim 8, further comprising:
reducing the resolution of the reduced image features at a subsequent intermediate stage of the diffusion model using a subsequent wavelet transform to obtain further reduced image features.

13. The method of claim 8, further comprising:
increasing the reduced resolution of the reduced image features to obtain processed image features at the resolution of the image features.

14. An apparatus for image processing, comprising:
a processor;
a memory storing instructions executable by the processor; and
a diffusion model comprising:
an encoder configured to encode an input image to obtain image features;
a denoising network comprising resolution reduction layer configured to reduce a resolution of the image features at an intermediate stage of the diffusion model using a wavelet transform to obtain reduced image features at a reduced resolution; and
a decoder configured to generate an output image based on the reduced image features.

15. The apparatus of claim 14, further comprising:
a training component configured to update parameters of the diffusion model.

16. The apparatus of claim 14, further comprising:
a user interface configured to receive a text prompt, wherein the diffusion model is configured to condition the output image based on the text prompt.

17. The apparatus of claim 14, wherein:
the denoising network comprises a U-Net architecture.

18. The apparatus of claim 14, wherein:
the diffusion model comprises a latent diffusion model.

19. The apparatus of claim 14, further comprising:
a noise component configured to add noise to an image to obtain the input image.

20. The apparatus of claim 14, wherein:
the denoising network includes an inverse wavelet transform configured to increase the reduced resolution of the reduced image features to obtain processed image features at the resolution of the image features.
